(19) United States
(12) Patent Application Publication
(10) Pub. No.: US 2005/0087236 A1
(43) Pub. Date: Apr. 28, 2005

(54) Fuel tank system of vehicle

(76) Inventor: Jae Jun Woo, Seoul (KR)

Correspondence Address: MORGAN, LEWIS & BOCKIUS LLP (SF), 2 PALO ALTO SQUARE, PALO ALTO, CA, 94306, US

(21) Appl. No.: 10/857,144

(22) Filed: May 28, 2004

(30) Foreign Application Priority Data
Oct. 24, 2003 (KR) 10-2003-0074752

(51) Int. Cl. F17D 1/00

(52) U.S. Cl. 137/572

(57) ABSTRACT

For enhanced stability of fuel supply to an engine, a fuel tank system of a vehicle has a first and a second fuel tank for storing fuel. The tanks are interconnected by a connecting pipe with a one-way valve disposed in the connecting pipe such that fuel can flow from a filling tank to an engine supply tank but not in the reverse direction.

### CROSS-REFERENCE TO RELATED APPLICATIONS

This application claims priority to Korean Application No. 10-2003-0074752, filed on Oct. 24, 2003, the disclosure of which is incorporated fully here by reference.

### FIELD OF THE INVENTION

Generally, the present invention relates to a fuel tank system for a vehicle. More particularly, the fuel tank system enhances the stability of fuel supplied to an engine.

### BACKGROUND OF THE INVENTION

Various kinds of fuels are used for vehicles and fuel tank systems for storing the same are accordingly designed in various fashions. As an example, two fuel tanks connected to each other are sometimes used to store fuel, and the fuel is extracted from one of the fuel tanks and supplied to an engine. Such a dual fuel tank system is frequently used for a Liquefied Petroleum Gas (LPG) fuel tank system of a Liquefied Petroleum Gas (LPG) engine powered vehicle.

In a dual fuel tank system, a fuel pump is installed with one of the two fuel tanks for extracting fuel therefrom. When the fuel pump is designed to extract liquid fuel from the bottom of the fuel tank, the following problem often occurs. When a vehicle equipped with a dual fuel tank system is moving, the relative position of the two fuel tanks to each other and to the ground often changes depending on the terrain and driving circumstances. That is, even if the dual fuel tank system is designed to lie horizontally when the vehicle is stationary or positioned on a horizontal surface, one fuel tank may become lower than the other fuel tank in the case that the vehicle is under hard deceleration or running on a downgrade. To the contrary, one fuel tank may become higher than the other tank when the vehicle is under hard acceleration or running on an upgrade. In such cases, fuel stored in the fuel tank having the fuel pump may return to the other fuel tank, and accordingly the fuel pump may fail to stably extract the fuel, resulting in the fuel supply to an engine becoming unstable.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

The present invention provides a fuel tank system for a vehicle that provides stability of fuel supplied to an engine.

An exemplary fuel tank system of a vehicle according to an embodiment of the present invention includes a first fuel tank for storing a fuel, a second fuel tank for storing the fuel, at least one connecting pipe for interconnecting the first and second fuel tanks, and a one-way valve disposed within the connecting pipe.

A fuel tank system of a vehicle according to a further embodiment includes a fuel pump for extracting the fuel from the first fuel tank, wherein the one-way valve prevents the fuel from returning from the first fuel tank to the second fuel tank.

In yet a further embodiment, the second fuel tank is provided with a fuel feeder for feeding the liquid fuel thereto. According to a further embodiment, the one-way valve prevents the liquid fuel from returning from the first fuel tank to the second fuel tank.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a perspective view of a fuel tank system of a vehicle according to an embodiment of the present invention;

FIG. 2 is a sectional view of the fuel tank system taken along a line II-II of FIG. 1; and

FIG. 3 is an enlarged partial sectional view of portion A of FIG. 1.

### DETAILED DESCRIPTION OF THE PREFERRED EMBODIMENTS

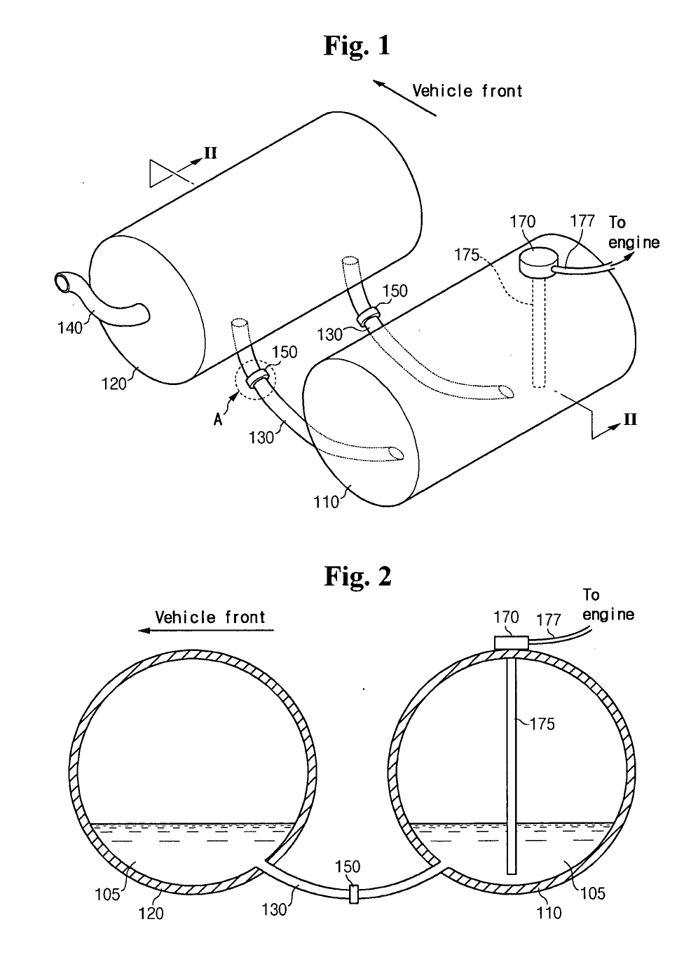

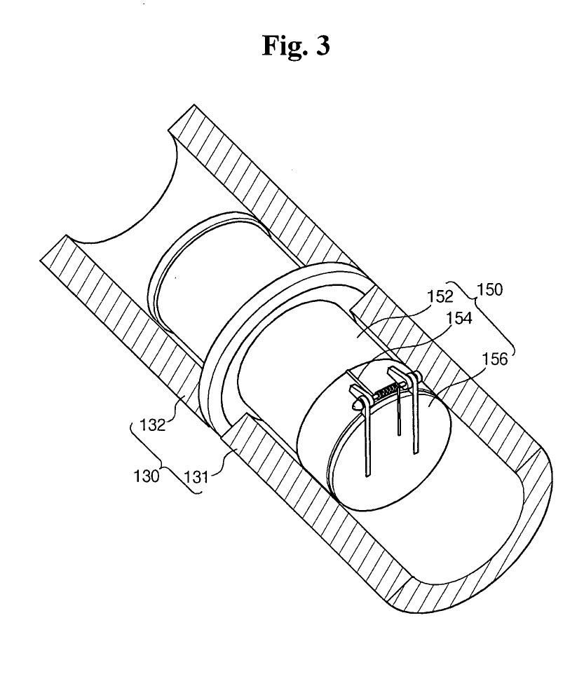

FIG. 1 shows a fuel tank system of a vehicle according to an embodiment of the present invention, and FIG. 2 is a sectional view of FIG. 1 taken along a line II-II. As shown in FIG. 1, fuel of a liquid or gas state can be stored in each of a first and a second fuel tank 110 and 120, respectively. An exterior of either of the first and second fuel tanks 110 and 120 are shown having a cylindrical shape but it will be appreciated by one of ordinary skill in the art that the tanks can have any shape. The first and second fuel tanks 110 and 120, respectively, are interconnected by at least one connecting pipe 130. The connecting pipe 130 may have any cross-sectional shape, and may be formed of any material that is conventionally accepted for use with the particular fuel used in the associated tanks and engine, as will be appreciated by one of ordinary skill in the art.

A one-way valve 150 is disposed within the connecting pipe 130. When the first and second fuel tanks 110 and 120 are interconnected by a plurality of connecting pipes 130, each connecting pipe 130 is provided with a one-way valve 150.

The second fuel tank 120 is provided with a fuel feeder 140 for feeding the fuel 105 thereto. A fuel pump 170 is positioned within the first tank 120 for extracting the fuel 105 therefrom. The fuel pump 170 extracts the fuel 105 through a fuel induction pipe 175 that extends towards the bottom of the first fuel tank 110, such that the fuel pump 170 is in fluid communication with fuel 105 in the tank. The fuel 105 is then removed from the tank and provided to the engine through a fuel delivery pipe 177.

The one-way valve 150 prevents the fuel 105 from returning from the first fuel tank 110 provided with the fuel pump 170 to the second fuel tank 120. An example of the one-way valve 150 is illustrated in FIG. 3. The connecting pipe 130 is divided to front and rear connecting pipes 132 and 131, and the one-way valve 150. The one-way valve 150 may be realized by a body 152 and a plate 156. The plate 156 is hingedly supported to the body 152 by a spring 154 that urges the plate 156 to close an opening in the body 152. Therefore, the fuel 105 may move from the front connecting pipe 132 to the rear connecting pipe 131 overcoming an elastic force of the spring 154, but it cannot move from the rear connecting pipe 131 to the front connecting pipe 132 because the spring urges the plate 156 to a closed position in that direction.

The first fuel tank 110 may store at least more fuel 105 than is stored in the second fuel tank 120 because the fuel 105 stored in the second fuel tank 120 can move to the first fuel tank 110 through the one-way valve 150. However, the one-way valve 150 prevents the fuel 105 of the first fuel tank 110 from moving to the second fuel tank 120 in response to pressure in the rear connecting pipe 131 or against motion of the vehicle. Therefore, even when the second fuel tank 120 becomes positioned physically lower, such as when the vehicle is on a grade, fuel stored in the first fuel tank 110 can be maintained at a present level, and accordingly, the fuel pump 170 can stably extract the fuel and supply it to an engine.

According to an embodiment of the present invention, the one-way valve separates two fuel tanks, and therefore a mal-effect due to a biasing of fuel may be reduced. Such a one-way valve prevents the fuel from returning from a fuel tank provided with a fuel pump to another second tank, thus, enhancing the stability of fuel supply to an engine. In addition, such a one-way valve prevents the fuel from returning to a filling fuel tank and, therefore, the possibility of excessive filling of (or overflowing from) the fuel tank can be reduced.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A fuel tank system of a vehicle, comprising:
a first fuel tank for storing a fuel;
a second fuel tank for storing the fuel;
a connecting pipe for interconnecting the first and second fuel tanks; and
a one-way valve disposed within the connecting pipe.

2. The fuel tank system of claim 1, further comprising a fuel pump for extracting the fuel from the first fuel tank, wherein the one-way valve prevents the fuel from returning from the first fuel tank to the second fuel tank.

3. The fuel tank system of claim 2, wherein the second fuel tank is provided with a fuel feeder for initially receiving the fuel.

4. The fuel tank system of claim 1, wherein:
the second fuel tank is provided with a fuel feeder for, feeding the fuel thereto; and
the one-way valve prevents the fuel from returning from the first fuel tank to the second fuel tank.

5. A fuel tank system for a vehicle, comprising:
at least two fuel tanks;
at least one connecting pipe interconnecting said at least two fuel tanks such that said fuel tanks are maintained in fluid communication, wherein said at least one connecting pipe interconnects said fuel tanks toward a bottom of said fuel tanks;
a fuel feeder pipe connected to a first fuel tank of said at least two fuel tanks;
a fuel induction pipe disposed in a second fuel tank of said at least two fuel tanks and coupled with a fuel pump for withdrawing fuel from the second fuel tank and pumping fuel to an engine; and
a one way valve disposed within said at least one connecting pipe for regulating flow of fuel from the first fuel tank towards the second fuel tank and restricting flow in the direction from the second fuel tank towards the first fuel tank, wherein said one way valve includes a tubular body, a plate hingedly attached to the tubular body, and a biasing member disposed to provide a closing force on the plate such that the plate is urged against the tubular body.

6. A fuel supply system for a vehicle, comprising:
a vehicle having an engine;
a fuel supply system, wherein said fuel supply system includes;
at least a first and a second fuel tank;
at least one interconnecting line between said fuel tanks for fluidly connecting said fuel tanks;
a one way valve positioned within said interconnecting line such that fuel can flow from said second fuel tank to said first fuel tank but not from said first fuel tank to said second fuel tank;
a fuel pump and a fuel pick up line associated with said first fuel tank; and
a fuel feeder line associated with said second fuel tank for receiving fuel into said fuel supply system from an outside fuel supply source.
